(19) United States
(12) Patent Application Publication
(10) Pub. No.: US 2022/0251414 A1
(43) Pub. Date: Aug. 11, 2022

(54) CROSSLINKABLE COATING COMPOSITIONS

(71) Applicant: Elementis Specialties, Inc., East Windsor, NJ (US)

(72) Inventors: Yanhui CHEN, Princeton, NJ (US); Maurice GRAY, Saint Albans, NY (US); Rajni GUPTA, Princeton, NJ (US); Wouter Laurens IJDO, Yardley, PA (US)

(73) Assignee: Elementis Specialties, Inc., East Windsor, NJ (US)

(21) Appl. No.: 17/590,092

(22) Filed: Feb. 1, 2022

Related U.S. Application Data
(60) Provisional application No. 63/147,008, filed on Feb. 8, 2021.

(51) Int. Cl. C09D 175/14

(52) U.S. Cl. CPC C09D 175/14

(57) ABSTRACT

A crosslinkable coating composition comprising: ingredient A that has at least two protons that can be activated to form a Michael carbanion donor, wherein ingredient A is selected from the group consisting of an acetoacetate group containing compound, an acetoacetate group containing oligomer, an acetoacetate group containing polymer and combinations thereof; ingredient B that functions as a Michael acceptor having at least two ethylenically unsaturated functionalities each activated by an electron-withdrawing group; a surface modifying agent selected from the group consisting of perfluorosurfactants, polyacrylates, polyacrylate copolymers, fluorocarbon polyacrylates, fluorocarbon polyacrylate copolymers, polysiloxane and copolymers thereof and combinations thereof; and a chemical activator.

### CROSS REFERENCE TO RELATED APPLICATIONS

The application claims priority benefit from U.S. Provisional Patent Application No. 63/147,008 filed Feb. 8, 2021, which is incorporated by reference herein in its entirety.

### FIELD OF THE INVENTION

The invention provides for crosslinkable coating compositions having improved gloss properties.

### BACKGROUND OF THE INVENTION

The coatings industry continues to develop new chemistries as performance requirements for decorative and functional coatings evolve. Drivers for change are varied and these can include: regulatory controls to reduce VOC emissions, concerns about toxic hazards of coating raw materials, a desire for cost reduction, commitments to sustainability, and a need for increased product effectiveness.

Highly crosslinked, durable coating compositions can be achieved using Michael addition chemistry. The Michael addition reaction involves the nucleophilic addition of a Michael donor, such as a carbanion or another nucleophile to a Michael acceptor, such as an α,β-unsaturated carbonyl. As such, the base catalyzed addition of activated methylene moieties to electron deficient C═C double bonds are known in coatings applications. Representative examples of suitable materials that can provide activated methylene or methine groups are generally disclosed in U.S. Pat. No. 4,871,822, which resins contain a methylene and/or monosubstituted methylene group in the alpha-position to two activating groups such as, for example, carbonyl, cyano, sulfoxide and/or nitro groups. Preferred are resins containing a methylene group in the alpha-position to two carbonyl groups, such as malonate and/or acetoacetate group-containing materials, malonates being most preferred. The α,β-unsaturated carbonyl typically is an acrylate material and representative materials have been disclosed in U.S. Pat. No. 4,602,061. The Michael reaction is fast, can be carried out at ambient temperatures and gives a chemically stable crosslinking bond without forming any reaction by-product.

A typical crosslinkable coating composition comprises a resin ingredient A (Michael donor), a resin ingredient B (Michael acceptor) and a base to start and catalyze the Michael addition reaction. The base catalyst should be strong enough to abstract, i.e., activate a proton from resin ingredient A to form the Michael donor carbanion species. Since the Michael addition cure chemistry can be very fast, the coating formulator is challenged to control the speed of the reaction to achieve an acceptable balance of pot life, open time, tack free time and cure time. Pot life is defined as the amount of time during which the viscosity of a mixed reactive system doubles. Working life or working time informs the user how much time they have to work with a reactive two part system before it reaches such a high state of viscosity, or other condition, that it cannot be properly worked with to produce an acceptable application result. Gel time is the amount of time it takes for a mixed, reactive resin system to gel or become so highly viscous that it has lost fluidity. The open time of a coating is a practical measure of how much time it takes for a drying or curing coating to reach a stage where it can no longer be touched by brush or roller when applying additional coating material without leaving an indication that the drying or curing coating and newly applied coating did not quite flow together. These indications normally take the form of brush or roller marks and sometimes a noticeable difference in sheen levels. The tack free time is the amount of time it takes for a curing or drying coating to be no longer sticky to the touch, i.e., the time for a system to become hard to the touch, with no tackiness. Cure time is the amount of time it takes for a coating system to reach full final properties.

The Michael reaction starts the very moment when coating resin ingredients A and B are mixed together with a suitable base. Since it is a fast reaction, the material in a mixing pot starts to crosslink and the fluid viscosity starts to rise. This limits the pot life, working time and general use as a coating. A chemical activator that is essentially passive while coating material remains in a mixing vessel but that activates the Michael addition reaction upon film formation allows for longer pot life and working time, yet would show good open time, tack free time and cure time. Hence, the application of such chemical activator technology can provide the formulator with tools to control the speed of the reaction in order to achieve desirable cure characteristics.

U.S. Pat. No. 8,962,725 describes a blocked base catalyst as a chemical activator for Michael addition. The chemical activator is based on substituted carbonate salts. Preferred Michael donor resins are based on malonate and preferred Michael acceptor resins are acrylates. The substituted carbonates can bear substituents, but these should not substantially interfere with the crosslinking reaction between malonate and acrylate. The carbonate salts release carbon dioxide and a strong base upon activation by means of film formation. The base is either hydroxide or alkoxide.

U.S. Pat. No. 10,799,443 describes carbamate initiator compositions that function as a chemical activator. These activator materials can unleash reaction between Michael donor and acceptor moieties to produce crosslinked coating compositions. The carbamate initiator releases carbon dioxide and ammonia or an amine upon donor activation and start of the Michael addition reaction. The initiated Michael reaction may proceed “as is” or be catalyzed by base.

The Michael addition reaction to yield a crosslinked coating can be extremely fast at ambient conditions. Coating cure speed depends on a variety of factors, such as for instance total density of crosslinkable moieties, functionality (number of reactive sites on a resin molecule, oligomer or polymer), chemical composition, percent solids of the coating, solvent type(s) and amounts that are present, performance additives, fillers, etc. These are all well known in the coatings industry.

However, a fast coating cure can give rise to coatings appearance issues, such as reduced gloss or even wrinkling that yields a non-smooth surface. Such issues can be caused by different cure speeds and cure progression within the coating film. A delayed solvent evaporation during cure can also cause coatings appearance and quality issues. In another causative example, a rapid cure of the surface on top of a slower curing bulk layer underneath said surface can lead to formation of a thin solid film on top of a still liquid like, slower curing layer. This can lead to coating surface wrinkling and may produce other defects as well that all result in an unattractive appearance of a final cured coating.

Surface modifying agents are commonly used in the coating industry to control surface tension, flow and leveling of coatings in order to produce a coating with a nice appearance. Interestingly enough, Michael addition coatings that utilize malonate as donor resin do not show good appearance when surface modifying agents are employed to control surface characteristics. Materials that comprise acetoacetate groups are synergistic with surface modifying agents in that this combination achieves good coating surface results with respect to anti wrinkling effects and gloss.

### SUMMARY OF THE INVENTION

In one embodiment, the present invention provides for a crosslinkable coating composition comprising: ingredient A that has at least two protons that can be activated to form a Michael carbanion donor wherein ingredient A is selected from the group consisting of an acetoacetate group containing compound, an acetoacetate group containing oligomer, an acetoacetate group containing polymer and combinations thereof; ingredient B that functions as a Michael acceptor having at least two ethylenically unsaturated functionalities each activated by an electron-withdrawing group; a surface modifying agent selected from the group consisting of perfluorosurfactants, polyacrylates, polyacrylate copolymers, fluorocarbon polyacrylates and polysiloxane and copolymers thereof and combinations thereof, and a chemical activator selected from the group of: (i) a dormant carbamate initiator of Formula (1)

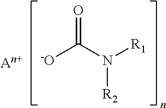

or
(ii) a carbonate catalyst of Formula (2)

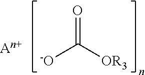

or (iii) combinations thereof,
wherein R₁, R₂ and R₃ can be independently selected from hydrogen, a linear or branched substituted or unsubstituted alkyl group having 1 to 22 carbon atoms; 1 to 8 carbon atoms;
Aⁿ⁺ is a cationic species or polymer and n is an integer equal or greater than 1 with the proviso that Aⁿ⁺ is not an acidic hydrogen.

In some embodiments, the crosslinkable coating composition further comprises ammonium carbamate (H₂NR₁R₂⁺⁻OC═ONR₁R₂).

In one such embodiment, the dormant carbamate initiator initiates Michael Addition to achieve cross linking when the crosslinkable coating composition is applied to a surface.

In another embodiment, the present invention provides for the crosslinkable coating composition wherein the acetoacetate group containing compound, oligomer, or acetoacetate group containing polymer are each selected from the group consisting of: polyurethanes, polyesters, polyesterurethanes, polyacrylates, epoxy polymers, polyamides, polyesteramides and polyvinyl polymers. In some embodiments, such compounds, oligomers or polymers have an acetoacetate group located in a main chain of such compound or oligomer or polymer or a side chain of such compound or oligomer or polymer.

In another embodiment, the present invention provides for the crosslinkable coating composition wherein ingredient B is selected from the group consisting of acrylates, fumarates, maleates and combinations thereof. In one such embodiment, the present invention provides for the crosslinkable coating composition wherein the acrylate is independently selected from the group consisting of hexanediol diacrylate, trimethylolpropane triacrylate, pentaerythritol triacrylate, di-trimethylolpropane tetraacrylate, bis(2-hydroxyethyl acrylate) trimethylhexyl dicarbamate, bis(2-hydroxyethyl acrylate) 1,3,3-trimethylcyclohexyl dicarbamate, bis(2-hydroxyethyl acrylate) methylene dicyclohexyl dicarbamate and combinations thereof.

In one such embodiment, the present invention provides for the crosslinkable coating composition wherein ingredient B is independently selected from polyesters, polyester urethanes, polyurethanes, polyethers, alkyd resins, and combinations thereof, each containing at least two pendant ethylenically unsaturated groups each activated by an electron-withdrawing group.

In one such embodiment, the present invention provides for the crosslinkable coating composition wherein ingredient B is independently selected from the group consisting of polyesters, polyester urethanes, polyurethanes, polyethers and/or alkyd resins each containing at least one pendant acryloyl functional group.

In another embodiment, the present invention provides for the crosslinkable coating composition further comprising an ingredient C having one or more reactive protons that are more acidic than the protons of ingredient A, with respect to pKa. In one such embodiment, the present invention provides for the crosslinkable coating composition wherein the one or more reactive protons of ingredient C are less acidic than the ammonium cation of the optional ammonium carbamate, with respect to pKa.

In another embodiment, the present invention provides for the crosslinkable coating composition further comprising less than 10 wt. %; 5 wt. %; 1 wt. %; 0.1 wt. %; 0.01 wt. % water. In another embodiment, the present invention provides for the crosslinkable coating composition substantially free of water.

In another embodiment, the present invention provides for the crosslinkable coating composition further comprising an organic solvent. In one such embodiment, the organic solvent is independently selected from an alcohol, ester, ether, glycol ether, ketone, aromatic and combinations thereof. In one such embodiment, the solvent is independently selected from ethanol, iso-propanol, butanol, iso-butanol, t-butanol, acetone, ethyl acetate, butyl acetate, methyl ethyl ketone and combinations thereof.

In another embodiment, the present invention provides for the crosslinkable coating composition wherein A⁺ⁿ is a monovalent quaternary ammonium compound of Formula (2)

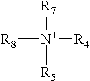

wherein R₄, R₅ and R₆ are independently selected from linear or branched alkyl chains having from 1 to 22 carbon atoms; or 1 to 8 carbon atoms and combinations thereof, and wherein R₇ is independently selected from the group consisting of: methyl, an alkyl group having from 2 to 6 carbon atoms or a benzyl group.

In another embodiment, the present invention provides for a polymerizable coating composition comprising the crosslinkable coating composition described herein. In one such embodiment, the polymerizable coating composition includes at least one solvent selected from ethanol, iso-propanol, butanol, iso-butanol, t-butanol, acetone, ethyl acetate, butyl acetate, methyl ethyl ketone and combinations thereof. In another certain embodiment, the polymerizable coating composition further includes one or more of dyes, pigments, effect pigments, phosphorescent pigments, flakes and fillers and combinations thereof. In another certain embodiment, the polymerizable coating composition further includes a rheological additive to modify rheology. In another certain embodiment, the polymerizable coating composition further includes a wetting agent. In another embodiment, the polymerizable coating composition further includes an adhesion promotor.

### DETAILED DESCRIPTION

The invention disclosed here is a crosslinkable composition comprising a resin ingredient A (Michael donor), a resin ingredient B (Michael acceptor), a surface modifying agent, a chemical activator and optionally ammonium carbamate.

Resin ingredient A (Michael donor): Resin ingredients A are compounds, oligomers or polymers that contain functional groups that have reactive protons that can be activated to produce a carbanion Michael donor. In one embodiment, the functional group can be a methylene or methine group and resins have been described in U.S. Pat. Nos. 4,602,061 and 8,962,725, for example. In one embodiment, the present invention provides for a crosslinkable coating composition comprising: ingredient A that has at least two protons that can be activated to form a Michael carbanion donor, wherein ingredient A is selected from the group consisting of an acetoacetate group containing compound, an acetoacetate group containing oligomer, an acetoacetate group containing polymer or combinations thereof. In one such embodiment, the acetoacetate group containing compound, oligomer, or acetoacetate group containing polymer are each selected from the group consisting of: polyurethanes, polyesters, polyesterurethanes, polyacrylates, epoxy polymers, polyamides, polyesteramides or polyvinyl polymers.

In some embodiments, such acetoacetate group containing compounds, oligomeric or polymers are acetoacetate ester compounds, oligomers or polymers. Examples of such acetoacetic esters are disclosed in U.S. Pat. No. 2,759,913, examples of such diacetoacetate resins are disclosed in U.S. Pat. No. 4,217,396 and examples of such acetoacetate group-containing oligomeric and polymeric resins are disclosed in U.S. Pat. No. 4,408,018. In some embodiments, acetoacetate group-containing compounds, oligomers and polymer resins can be obtained, for example, from polyalcohols and/or hydroxyl-functional polyether, polyester, polyacrylate, vinyl and epoxy oligomers and polymers by reaction with diketene or transesterification with an alkyl acetoacetate. Such resins may also be obtained by copolymerization of an acetoacetate functional (meth)acrylic monomer with other vinyl- and/or acrylic-functional monomers. In certain other embodiments, the acetoacetate group-containing resins for use with the present invention are the acetoacetate group-containing oligomers and polymers containing at least 1, or 2-10, acetoacetate groups. In some such embodiments, such acetoacetate group containing resins should have Mn in the range of from about 100 to about 5000 g/mol, and an acid number of about 2 or less.

In one embodiment, acetoacetate group containing polymers may also be obtained from reaction with acetoacetonate with polyols, such as those polyols that are commercially sold for reaction with isocyanates to form polyurethane coatings.

In one embodiment, malonate group containing compound, oligomer or polymer and acetoacetate group-containing compound, oligomer or polymer may also be blended to optimize coatings properties as desired, often determined by the intended end application. Using the molar amounts of acetoacetate groups and malonate groups in these blends to define the total moles in the denominator when calculating a mole fraction; the mole fraction of acetoacetate groups in such blends ranges from 0.99-0.15; 0.99-0.20; or 0.99-0.35.

In another embodiment, the present invention provides for a crosslinkable coating composition comprising: ingredient A that has at least two protons that can be activated to form a Michael carbanion donor, wherein ingredient A is selected from the group consisting of a malonate group containing compound, a malonate group containing oligomer, a malonate group containing polymer or combinations thereof. In one such embodiment, resin ingredients A are those derived from malonic acid or malonate esters, i.e., malonate. Oligomeric or polymeric malonate compounds include polyurethanes, polyesters, polyacrylates, epoxy resins, polyamides, polyesteramides or polyvinyl resins each containing malonate groups, either in the main chain or the side chain or in both.

In one embodiment, polyurethanes having malonate groups may be obtained, for instance, by bringing a polyisocyanate into reaction with a hydroxyl group containing ester or polyester of a polyol and malonic acid/malonates, by esterification or transesterification of a hydroxyl functional polyurethane with malonic acid and/or a dialkyl malonate. Examples of polyisocyanates include hexamethylenediisocyanate, trimethylhexamethylene diisocyanate, isophorone diisocyanate, toluene diisocyanate and addition products of a polyol with a diisocyanate, such as that of trimethylolpropane to hexamethylene diisocyanate. In one embodiment, the polyisocyanate is selected from isophorone diisocyanate and trimethylhexamethylene diisocyanate. In another embodiment, the polyisocyanate is isophorone diisocyanate. In some embodiments, hydroxyl functional polyurethanes include the addition products of a polyisocyanate, such as the foregoing polyisocyanates, with di- or polyvalent hydroxyl compounds, including diethyleneglycol, neopentyl glycol, dimethylol cyclohexane, trimethylolpropane, 1,3-propanediol, 1,4-butanediol, 1,6-hexanediol and polyether polyols, polyester polyols or polyacrylate polyols. In some embodiments, the di- or polyvalent hydroxyl compounds include diethyleneglycol, 1,3-propanediol, 1,4-butanediol and 1,6-hexanediol. In other embodiments, the di- or polyvalent hydroxyl compounds include diethyleneglycol and 1,6-hexanediol.

In one embodiment, malonic polyesters may be obtained, for instance, by polycondensation of malonic acid, an alkylmalonic acid, such as ethylmalonic acid, a mono- or dialkyl ester of such a carboxylic acid, or the reaction product of a malonic ester and an alkylacrylate or methacrylate, optionally mixed with other di- or polycarboxylic with one or more dihydroxy and/or polyhydroxy compounds, in combination or not with mono hydroxyl compounds and/or carboxyl compounds. In some embodiments, polyhydroxy compounds include compounds containing 2-6 hydroxy groups and 2-20 carbon atoms, such as ethylene glycol, diethyleneglycol, propylene glycol, trimethylol ethane, trimethylolpropane, glycerol, pentaerythritol, 1,4-butanediol, 1,6-hexanediol, cyclohexanedimethanol, 1,12-dodecanediol and sorbitol. In some embodiments, the polyhydroxy compounds include diethylene glycol, propylene glycol, 1,4-butanediol and 1,6-hexanediol. In other embodiments, the polyhydroxyl compounds include propylene glycol and 1,6-hexanediol. In certain embodiments, the polyhydroxy may be a primary alcohol and in certain other embodiments, the polyhydroxy may be a secondary alcohol. Examples of polyols with secondary alcohol groups are 2,3-butanediol, 2,4-pentanediol and 2,5-hexanediol and the like.

In one embodiment, malonate group-containing polymers also may be prepared by transesterification of an excess of dialkyl malonate with a hydroxyl functional polymer, such as a vinyl alcohol-styrene copolymer. In this way, polymers with malonate groups in the side chains are formed. After the reaction, the excess of dialkyl malonate may optionally be removed under reduced pressure or be used as reactive solvent.

In one embodiment, malonate group containing polymers may also be obtained from reaction with malonate with polyols, such as those polyols that are commercially sold for reaction with isocyanates to form polyurethane coatings.

In one embodiment, malonic epoxy esters may be prepared by esterifying an epoxy polymer with malonic acid or a malonic monoester, or by transesterifying with a dialkylmalonate, optionally in the presence of one or more other carboxylic acids or derivatives thereof.

In one embodiment, polyamides having malonate groups may be obtained in the same manner as polyesters, at least part of the hydroxyl compound(s) being replaced with a mono- or polyvalent primary and/or secondary amine, such as cyclohexylamine, ethylene diamine, isophorone diamine, hexamethylene diamine, or diethylene triamine.

In some embodiments, such polyamide compounds can be obtained when 12-hydroxystearic acid is reacted with a diamine such as ethylenediamine. Such polyamides have secondary alcohol groups, which can be esterified with malonic acid or malonate in a second reaction step. In some embodiments, other diamines may also be used in the reaction with 12-hydroxystearic acid, for example: xylylenediamine, butylenediamine, hexamethylenediamine, dodecamethylenediamine, and even dimer amine, which is derived from dimer acid. Polyamines may also be used, but in a right stoichiometric ratio as to avoid gelling of the polyamide in the reactor. Lesquerolic acid may also be used in reactions with polyamines to yield polyamides bearing secondary alcohol groups, which can be used in reactions with malonate to form malonate containing compounds. Reactions that yield malonamides are much less desirable.

In some embodiments, the above-mentioned malonate resins may be blended together to achieve optimized coatings properties. Such blends can be mixtures of malonate-modified polyurethanes, polyesters, polyacrylates, epoxy resins, polyamides, polyesteramides and the like, but mixtures can also be prepared by blending various malonate-modified polyesters together. In some other embodiments, various malonate-modified polyurethanes, various malonate-modified polyacrylates, malonate-modified epoxy resins, various malonate-modified polyamides, and/or various malonate-modified polyesteramides can be mixed together.

In certain embodiments, malonate resins are malonate group containing oligomeric esters, polyesters, polyurethanes, or epoxy esters having 1-100, or 2-20 malonate groups per molecule. In some such embodiments, the malonate resins should have a number average molecular weight in the range of from 250 to 10,000 g/mole and an acid number not higher than 5 mg KOH/g, or not higher than 2 mg KOH/g. Use may optionally be made of malonate compounds in which the malonic acid structural unit is cyclized by formaldehyde, acetaldehyde, acetone or cyclohexanone. In some embodiments, molecular weight control may be achieved by the use of end capping agents, typically monofunctional alcohol, monocarboxylic acid or esters. In one embodiment, malonate compounds may be end capped with one or more of 1-hexanol, 1-octanol, 1-dodecanol, hexanoic acid or its ester, octanoic acid or its esters, dodecanoic acid or its esters, diethyleneglycol monoethyl ether, trimethylhexanol, and t-butyl acetoacetate, ethyl acetoacetate. In one such embodiment, the malonate is end capped with 1-octanol, diethyleneglycol monoethyl ether, trimethylhexanol, t-butyl acetoacetate and ethyl acetoacetate. In another such embodiment, the malonate is end capped t-butyl acetoacetate, ethyl acetoacetate and combinations thereof.

Monomeric malonates may optionally be used as reactive diluents, but certain performance requirements may necessitate removal of monomeric malonates from resin ingredient A.

Structural changes at the acidic site of malonate or acetoacetate resins can alter the acidity of these materials and derivatives thereof. For instance, pKa measurements in DMSO show that diethyl methylmalonate (MeCH(CO₂Et)₂) has a pKa of 18.7 and diethyl ethylmalonate (EtCH(CO₂Et)₂) has a pKa of 19.1 whereas diethyl malonate (CH₂(CO₂Et)₂) has a pKa of 16.4. Resin ingredient A may contain such substituted moieties and therewith show changes in gel time, open time, cure time and the like. For example, resin ingredient A may be a polyester derived from a polyol, diethyl malonate and diethyl ethylmalonate.

Resin ingredient B (Michael acceptor): Resin ingredients B (Michael acceptor) generally can be materials with ethylenically unsaturated moieties in which the carbon-carbon double bond is activated by an electron-withdrawing group, e.g., a carbonyl group in the alpha-position. In some embodiments, resin ingredients B are described in: U.S. Pat. Nos. 2,759,913, 4,871,822, 4,602,061, 4,408,018, 4,217,396 and 8,962,725. In certain embodiments, resin ingredients B include acrylates, fumarates and maleates. In other certain embodiments, resin ingredient B is an unsaturated acryloyl functional resin.

In some embodiments, resin ingredients B are the acrylic esters of chemicals containing 2-6 hydroxyl groups and 2-20 carbon atoms. These esters may optionally contain hydroxyl groups. In some such embodiments, examples of such acrylic esters include hexanediol diacrylate, trimethylolpropane triacrylate, pentaerythritol triacrylate, and di-trimethylolpropane tetraacrylate. In one such embodiment, acrylic esters include trimethylolpropane triacrylate, di-trimethylolpropane tetraacrylate, dipentaerythritol hexaacrylate, pentaerythritol ethoxylated (EO)ₙ tetraacrylate, trimethylolpropane ethoxylated (EO)ₙ triacrylate and combinations thereof. In another embodiment, acrylamides may be used as a resin ingredient B.

In other embodiments, resin ingredients B are polyesters based upon maleic, fumaric and/or itaconic acid (and maleic and itaconic anhydride), and chemicals with di- or polyvalent hydroxyl groups, optionally including materials with a monovalent hydroxyl and/or carboxyl functionality.

In other embodiments, resin ingredients B are resins such as polyesters, polyesterurethanes, polyurethanes, polyethers and/or alkyd resins containing pendant activated unsaturated groups. In one such embodiment, the resin ingredients B include UV curing resins which are acrylate radical polymerizable resins. Such resins are commercially available. Further, these resin ingredients B include, for example, urethane acrylates obtained by reaction of a polyisocyanate with a hydroxyl group-containing acrylic ester, e.g., a hydroxyalkyl ester of acrylic acid or a resin prepared by esterification of a polyhydroxyl material with acrylic acid; polyether acrylates obtained by esterification of an hydroxyl group-containing polyether with acrylic acid; polyfunctional acrylates obtained by reaction of a hydroxyalkyl acrylate with a polycarboxylic acid and/or a polyamino resin; polyacrylates obtained by reaction of acrylic acid with an epoxy resin; and polyalkylmaleates obtained by reaction of a monoalkylmaleate ester with an epoxy polymer and/or a hydroxyl functional oligomer or polymer. In certain embodiments, polyurethane acrylate resins may be prepared by reaction of hydroxyalkyl acrylate with polyisocyanate. Such polyurethane acrylate resins independently include bis(2-hydroxyethyl acrylate) trimethylhexyl dicarbamate [2-hydroxyethyl acrylate trimethylhexamethylene diisocyanate (TMDI) adduct], bis(2-hydroxyethyl acrylate) 1,3,3-trimethylcyclohexyl dicarbamate [2-hydroxyethyl acrylate 1,3,3-trimethylcyclohexyl diisocyanate/isophorone diisocyanate (IPDI) adduct], bis(2-hydroxylethyl acrylate) hexyl dicarbamate [2-hydroxyethyl acrylate hexamethylene diisocyanate (HDI) adduct], bis(2-hydroxylethyl acrylate) methylene dicyclohexyl dicarbamate [2-hydroxyethyl acrylate methylene dicyclohexyl diisocyanate (HMDI) adduct], bis(2-hydroxyethyl acrylate) methylenediphenyl dicarbamate [2-hydroxyethyl acrylate methylenediphenyl diisocyanate (MDI) adduct], bis(4-hydroxybutyl acrylate) 1,3,3-trimethylcyclohexyl dicarbamate [4-hydroxybutyl acrylate IPDI adduct], bis(4-hydroxybutyl acrylate) trimethylhexyl dicarbamate [4-hydroxybutyl acrylate TMDI adduct], bis(4-hydroxybutyl acrylate) hexyl dicarbamate [4-hydroxybutyl acrylate HDI adduct], bis(4-hydroxybutyl acrylate) methylene dicyclohexyl dicarbamate [4-hydroxybutyl acrylate HMDI adduct], bis(4-hydroxybutyl acrylate) methylenediphenyl dicarbamate [4-hydroxybutyl acrylate MDI adduct].

In other embodiments, resin ingredients B have unsaturated acryloyl functional groups.

In certain embodiments, the acid value of the activated unsaturated group-containing material (resin ingredient B) is sufficiently low to not substantially impair the Michael addition reaction, for example less than about 2, and further for example less than 1 mg KOH/g.

As exemplified by the previously incorporated references, these and other activated unsaturated group containing resins, and their methods of production, are generally known to those skilled in the art, and need no further explanation here. In certain embodiments, the number of reactive unsaturated group ranges from 2 to 20, the equivalent molecular weight (EQW: average molecular weight per reactive functional group) ranges from 100 to 2000 g/mole, and the number average molecular weight Mn ranges from 100 to 5000 g/mole.

In one embodiment, the reactive part of resin ingredients A and B can also be combined in one A-B type molecule. In this embodiment of the crosslinkable composition, both the methylene and/or methine features as well as the α,β-unsaturated carbonyl are present in the same molecule, be it a monomer, oligomer or polymer. Mixtures of such A-B type molecules with ingredient A and B are also useful.

In the foregoing embodiments, the number of reactive protons for resin ingredients A, and the number of α,β-unsaturated carbonyl moieties on resin ingredient B can be utilized to express desirable ratios and ranges for resin ingredients A and B. Typically, the mole ratio of reactive protons of ingredient A that can be activated with subsequent carbanion formation relative to the activated unsaturated groups on ingredient B is in the range between 10:1 and 0.1:1, or between 4:1 and 0.25:1, or between 3.3:1 and 0.67:1. However, the optimal amount strongly depends also on the number of reactive groups present on ingredients A and/or B.

The amount of chemical activator used, expressed as mole ratio of protons that can be abstracted to form an activated Michael donor species (e.g., the methylene group of malonate can provide two protons for reactions, while a methine group can provide one proton to form an activated species) relative to initiator, ranges from about 1000:1 to 1:1, or from 250:1 to 10:1, or from 125:1 to 20:1 but the optimal amount to be used depends also on the amount of solvent present, reactivity of various acidic protons present on resin ingredients A and/or B.

The surface modifying agent is selected from the group consisting of perfluorosurfactants, polyacrylates, polyacrylate copolymers, fluorocarbon polyacrylates and copolymers and polysiloxane and copolymers thereof and combinations thereof. The surface modifying agent can also be a mixture of aforementioned surface modifying agents.

The chemical activator can be a dormant carbamate initiator with a structure shown in Formula 1:

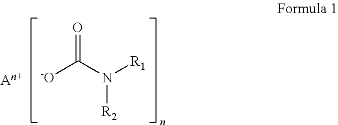

R₁ and R₂ can be independently selected and is hydrogen or an alkyl group with 1 to 22 carbon atoms where the alkyl group can be linear or branched. In some embodiments, the alkyl group has 1 to 8 carbon atoms or the alkyl group has 1 to 4 carbon atoms. In some such embodiments, the alkyl group is selected from a methyl group, ethyl group, propyl group, butyl group and combinations thereof. In certain embodiments, the alkyl groups are unsubstituted alkyl groups. In other embodiments, the alkyl group can be substituted. In certain embodiments, both R₁ and R₂ are substituted with hydroxyl groups. Aⁿ⁺ is a cationic material and n is an integer equal or greater than 1, with the proviso that Aⁿ⁺ is not an acidic hydrogen. In some embodiments, Aⁿ⁺ can be a monovalent cation, such as an alkali metal, earth alkali metal or another monovalent metal cation, a quaternary ammonium, a sulfonium or a phosphonium compound. In some embodiments, Aⁿ⁺ can also be a multivalent metal cation, or a compound bearing more than one quaternary ammonium or phosphonium group, or can be a cationic polymer. In certain embodiments, Aⁿ⁺ is a monovalent quaternary ammonium cation where n is 1. For the various embodiments described herein, dormant carbamate initiator ingredient C is significantly slow in promoting the Michael reaction prior to applying the crosslinkable composition of this invention as a coating so it can be regarded as essentially inactive, or minimally active, while in a container, yet the initiator initiates Michael addition reaction once the coating is applied as a film.

The chemical activator can also be a blocked carbonate catalyst of Formula (2)

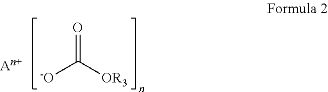

wherein R₃ can be independently selected from hydrogen, a linear or branched substituted or unsubstituted alkyl group having 1 to 22 carbon atoms or 1 to 8 carbon atoms; Aⁿ⁺ is a cationic species or polymer; and n is an integer equal or greater than 1, with the proviso that Aⁿ⁺ is not an acidic hydrogen. In some embodiments, Aⁿ⁺ can be a monovalent cation, such as an alkali metal, earth alkali metal or another monovalent metal cation, a quaternary ammonium, a sulfonium or a phosphonium compound. In some embodiments, Aⁿ⁺ can also be a multivalent metal cation, or a compound bearing more than one quaternary ammonium or phosphonium groups, or can be a cationic polymer. In certain embodiments, Aⁿ⁺ is a monovalent quaternary ammonium cation where n is 1.

In another embodiment, the chemical activator is a blocked catalyst system comprising diethyl carbonate, a quaternary ammonium hydroxide or a quaternary ammonium alkoxide, ethanol and 0-10 wt. % water relative to total weight of the crosslinkable composition.

In another embodiment, the blocked catalyst system comprises carbon dioxide, a quaternary ammonium hydroxide or a quaternary ammonium alkoxide, an alcohol and 0-10 wt. % water relative to total weight of the crosslinkable composition.

Examples of a quaternary ammonium cations, either as hydroxides or alkoxides, include dimethyldiethylammonium, dimethyldipropylammonium, triethylmethylammonium, tripropylmethylammonium, tributylmethylammonium, tripentylmethylammonium, trihexylmethylammonium tetraethylammonium, tetrapropylammonium, tetrabutylammonium, tetrapentylammonium, tetrahexylammonium, benzyltrimethylammonium, benzyltriethylammonium, benzyltripropylammonium, benzyltributylammonium, benzyltripentylammonium, and benzyltrihexylammonium. The alkoxide is a conjugate base of an alcohol and examples of the alkoxide include ethoxide, isopropoxide and tert-butoxide.

In some embodiments, the dormant carbamate initiator is derived from carbamates, (H₂NR₁R₂⁺⁻OC═ONR₁R₂), independently selected from ammonium carbamate, methylammonium methylcarbamate, ethylammonium ethylcarbamate, propylammonium propylcarbamate, isopropylammonium isopropylcarbamate, butylammonium butylcarbamate, isobutylammonium isobutylcarbamate, pentylammonium pentylcarbamate, and hexylammonium hexylcarbamate. In other embodiments, the dormant carbamate initiator is derived from carbamates independently selected from dimethylammonium dimethylcarbamate, diethylammonium diethylcarbamate, dipropylammonium dipropylcarbamate, dibutylammonium dibutylcarbamate, diisobutylammonium diisobutylcarbamate, dipentylammonium dipentylcarbamate, dihexylammonium dihexylcarbamate, and dibenzylammonium dibenzylcarbamate. In other embodiments, the dormant carbamate initiator is derived from carbamates independently selected from N-methylethylammonium methylethylcarbamate, N-methylpropylammonium methylpropylcarbamate, and N-methylbenzylammonium methylbenzylcarbamate. In some certain embodiments, the dormant carbamate initiator is derived from carbamates independently selected from dimethylammonium dimethylcarbamate, diethylammonium diethylcarbamate, dipropylammonium dipropylcarbamate, N-methylethylammonium methylethylcarbamate, and N-methylpropylammonium methylpropylcarbamate.

For the various embodiments of dormant carbamate initiator, described herein, the dormant carbamate initiator releases carbon dioxide and ammonia or an amine upon activating resin ingredient A by means of a shift in equilibrium. The invention is not meant to be limited by theory however, the overall activation equilibrium reaction can be envisioned as illustrated in equation 1, for example with a malonate material (R′ and R″ can be the same or different and can be an alkyl or a malonate containing polymer). The activation process produces the carbanion Michael donor.

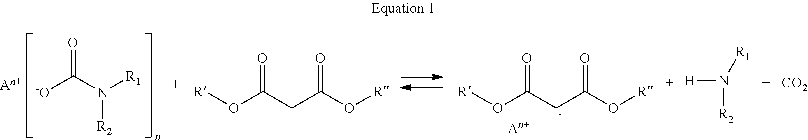

The carbanion can react with the Michael acceptor, an acrylate for example, to yield a malonate-acrylate adduct, which is very basic and is readily protonated, typically by another malonate methylene or methine moiety, thus restarting another cycle and continuing the Michael addition process. Solvent potentially can participate in the Michael addition cycle. The equilibrium of equation 1 can be shifted according to Le Chatelier's principle when ammonia or amine and carbon dioxide are allowed to leave the system, therewith unleashing the Michael addition reaction. However, the carbon dioxide and the ammonia or amine that are formed in equation 1 react exothermally with each other at a fast rate to form an ammonium carbamate in an equilibrium reaction that favors formation of the ammonium carbamate. This equilibrium reaction is shown in equation 2.

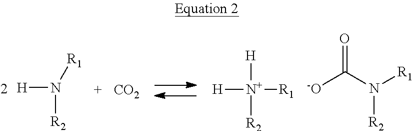

The protonated ammonium cation is a more acidic species (pKₐ≈9) than the malonate methylene group (pKₐ≈13) and reacts with a carbanion such as the malonate-acrylate adduct or the Michael donor carbanion of ingredient A, for example. Unless indicated otherwise, the pKa values described herein are defined on an aqueous basis. The initial carbamate initiator reforms in this reaction step. This process is illustrated in equation 3, where [Mal-Ac] is the malonate acrylate adduct.

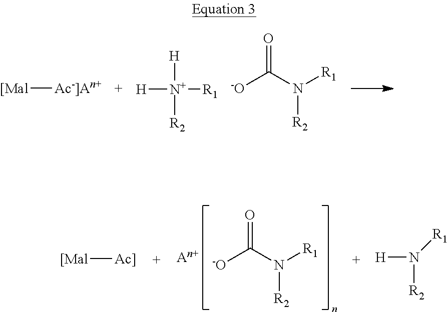

The dormant carbamate initiator thus is able to start the Michael addition cycle by means of a shift in equilibrium, but its decomposition products push back on the equilibrium and can react and stop the Michael reaction and regenerate the dormant carbamate initiator as long as amine and carbon dioxide are available. This ensures long pot life and gel time of the coating composition. Once the coating composition is applied on a substrate, the amine and carbon dioxide can escape into the atmosphere above the coating film and therewith unleash the full speed potential of the Michael addition reaction.

Only ammonia, primary and secondary amines can react with carbon dioxide to form ammonium carbamate material. Tertiary amines do not react with carbon dioxide to form carbamates. However, ammonia and amines can also react with acrylates at ambient conditions, albeit at different rates and these competing aza-Michael additions are illustrated in equation 4.

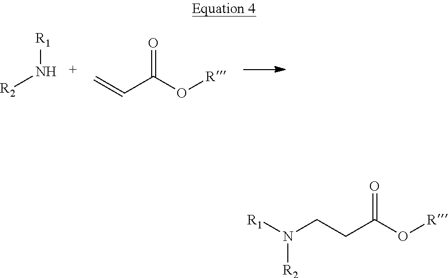

The inventors surprisingly found the carbamate initiator of formula 1 to be dormant in the crosslinkable composition of this invention despite the reaction shown in equation 4, which has the potential to drive a shift in equilibria. The reactions shown in equations 1, 2, 3 and 4 can be utilized to fine tune overall pot life, open time, cure rate and gel time. The reaction shown in equation 4 has an advantage in that it can remove undesirable amine odor from the curing coating as the dormant carbamate initiator activates.

In some embodiments, additional amine functional groups can optionally be added to the coating formulation to impact pot life, open time, cure rate and gel time. In another embodiment, both a quaternary ammonium carbamate, (A⁺⁻OC═ONR₁R₂), as well as an ammonium carbamate, (H₂NR₁R₂⁺⁻OC═ONR₁R₂), may be used together as a dormant initiator system. In yet another embodiment, excess carbon dioxide may be utilized to influence equilibria according to Le Chatelier's principle and thus influence pot life, open time, cure time and the like.

Another surprising result of this invention involves the dormant carbamate initiator and its interaction with acetoacetylated resins. Dormancy is preserved despite the fact that amines rapidly react with acetoacetic esters to yield a resin with enamine functionalities. Enamine and ketamines are tautomers. The two isomers readily interconvert with each other, with the equilibrium shifting depending on the polarity of the solvent/environment. Without being bound by theory, it is hypothesized that the enamine and ketamine groups convey increased methine/methylene acidity and the resin can crosslink in a reaction with α,β-unsaturated resins via Michael addition but the reactivity depends on the enamine/ketamine equilibrium. However, once the dormant carbamate initiator activates upon film formation and releases amine and carbon dioxide, the amine may preferentially react with acrylate or acetoacetate moieties in competing reactions, and thus significantly alter the crosslinking reaction characteristics during these initial stages when amine becomes available. The coating formulator thus has additional tools available by making use of the rich reaction chemistry that the amine offers by, for instance, using a mix of acetoacetate and malonate functional groups.

In some embodiments, the crosslinkable composition of this invention contains some solvent. The coating formulator may choose to use an alcohol, or a combination of alcohols as solvent for a variety of reasons. This is not a problem for the carbamate initiator, and regeneration thereof, because ammonia as well as primary and secondary amines react much faster with carbon dioxide than hydroxides or alkoxy anions. Other solvents like ethyl acetate or butyl acetate may also be used, potentially in combination with alcohol solvents. In such embodiments, the solvent is selected from ethanol, iso-propanol, butanol, iso-butanol, t-butanol, acetone, ethyl acetate, butyl acetate, methyl ethyl ketone and combinations thereof. In one embodiment, ethanol or isopropyl alcohol is the solvent. Methanol is not preferred as a solvent because of health and safety risks. Other oxygenated, polar solvents such as ester or ketones for instance, can be used, potentially in combination with alcohol. Other organic solvents may also be used. The crosslinkable composition of this invention may also be formulated without solvent in some cases. The crosslinkable coating contains typically at least 5 wt. % of solvent, or between 5 wt. % and 45 wt. %, or between 5 wt. % and 35 wt. %, or not more than 60 wt. % because of VOC restrictions.

In one embodiment, the crosslinkable coating composition further comprises less than 10 wt. %; 5 wt. %; 1 wt. %; 0.1 wt. %; or 0.01 wt. % water. In such embodiments, water may be present in the solvent, either deliberately added, or produced in situ in minor quantities during preparation of the dormant initiator. In another embodiment, the crosslinkable coating composition is substantially free of water.

The embodiments of dormant carbamate initiator, described herein, may be prepared in various ways. In one embodiment, the dormant carbamate initiator is prepared by ion exchange. In this embodiment, a cation exchange column is charged with quaternary ammonium ions, which in turn can replace the protonated amine of an ammonium carbamate so that a quaternary ammonium carbamate solution is obtained. In a certain embodiment, a concentrated solution of tributylmethylammonium chloride in water is passed through a cation exchange column. Next, the column is washed free of excess salt and rinsed with anhydrous alcohol to remove any residual water. In a next step, dimethylammonium dimethylcarbamate, NH₂(CH₃)₂⁺⁻OC═ON(CH₃)₂, optionally diluted with alcohol, is passed through the column so as to obtain a tributylmethylammonium dimethylcarbamate solution in alcohol. A similar approach with anionic ion exchange columns may be devised. The solution can be titrated with base or acid to assess the initiator concentration and whether the dormant initiator formation has been successful. Such analytical reactions are well known to one skilled in the art and need not be further described here.

In another embodiment, an ammonium carbamate solution may be treated with a strong base in alcohol. For example, dimethylammonium dimethylcarbamate is mixed with one molar equivalent of a tetrabutylammonium hydroxide dissolved in ethanol. This yields a tetrabutylammonium dimethylcarbamate solution after the neutralization reaction, as well as dimethyl amine and water. An excess of dimethylammonium dimethylcarbamate may also be used to ensure no residual hydroxide is left in the initiator solution and/or to increase pot life and gel time. In another embodiment, a carbamate such as dimethylammonium dimethylcarbamate may be treated with a quaternary ammonium ethoxide solution in ethanol. This will yield a quaternary ammonium dimethylcarbamate solution in ethanol, dimethylamine but no water is generated during the neutralization step.

In another embodiment, dimethylammonium dimethylcarbamate, is treated with an alcoholic solution of potassium t-butoxide to yield a solution of potassium dimethylcarbamate, dimethylamine and t-butanol.

In another embodiment, a diethyl malonate solution in ethanol is treated with a quaternary ammonium ethoxide prior to adding dimethylammonium dimethylcarbamate to yield a quaternary ammonium dimethylcarbamate solution in ethanol mixed with diethyl malonate and dimethylamine. In yet another embodiment, a quaternary ammonium hydroxide base, such as for instance, tetrabutylammonium hydroxide, is added to a solution of diethyl malonate in ethanol. Next, dimethylammonium dimethylcarbamate is added to yield a tetrabutylammonium dimethylcarbamate solution mixed with diethyl malonate, dimethylamine and water. In yet another embodiment, a strong alkoxide base like sodium ethoxide is added to a solution of diethyl malonate in ethanol. Next, a quaternary ammonium chloride salt is added, for instance tributylmethylammonium chloride, and the solution is filtered to remove sodium chloride salt. Next, a stoichiometric amount of dimethylammonium dimethylcarbamate is added to yield a solution of diethyl malonate, tributylmethylammonium carbamate and dimethylamine in ethanol. Malonate resin ingredient A may also be used in such reactions. In a certain embodiment, optionally in the presence of an organic solvent, resin ingredient A is first treated with a quaternary ammonium base, preferably a quaternary ammonium hydroxide solution, before adding an ammonium carbamate, potentially in excess, to yield a mixture of resin ingredient A, quaternary ammonium carbamate and amine.

In yet other embodiments, dialkyl ammonium dialkylcarbamates, or monoalkyl ammonium monoalkylcarbamates or ammonium carbamate or mixtures thereof may also be used, but those derived from smaller amines are preferred. Ammonium carbamates are readily prepared by reacting carbon dioxide with ammonia or amine. Mixtures of amines can also be used to prepare ammonium carbamate(s). Carbamate metal salt solutions can also be prepared as described in U.S. Pat. No. 5,808,013.

In certain embodiments, Aⁿ⁺ of formula 1 is a monovalent quaternary ammonium compound and the structure of this cation is shown in formula 2. A large selection of such quaternary ammonium compounds is commercially available from various manufacturers. In one embodiment, quaternary ammonium compounds are derived from tertiary amines which may be quaternized with a methyl or benzyl group. In one embodiment, tetra alkyl ammonium compounds also can be used. R₄, R₅, R₆ and R₇ are independently selected and are linear or branched alkyl chains having from 1 to 22 carbon atoms. In some such embodiments, R₄, R₅, R₆ and R₇ are tetra alkyl ammonium compounds where R₄, R₅, R₆ and R₇ are independently selected and range from 1 to 8. In some other such embodiments, ammonium compounds can be identified within this group and is dependent upon performance and raw materials costs. In certain embodiments, R₇ is a methyl or a benzyl group or an alkyl group having from 1 to 22 carbon atoms or from 2 to 6 carbon atoms. The quaternary ammonium compound is commercially available as a salt and the anion typically is chloride, bromide, methyl sulfate, or hydroxide. Quaternary ammonium compounds with methylcarbonate or ethylcarbonate anions are also available.

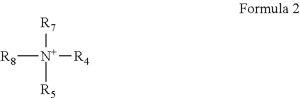

Examples of Aⁿ⁺ of formula 1 include dimethyldiethylammonium, dimethyldipropylammonium, triethylmethylammonium, tripropylmethylammonium, tributylmethylammonium, tripentylmethylammonium, trihexylmethylammonium tetraethylammonium, tetrapropylammonium, tetrabutylammonium, tetrapentylammonium, tetrahexylammonium, benzyltrimethylammonium, benzyltriethylammonium, benzyltripropylammonium, benzyltributylammonium, benzyltripentylammonium, benzyltrihexylammonium or combinations thereof.

In another embodiment of the invention, polyamines, potentially in combination with monoamines, may also be utilized as raw material for carbamate formation. In such embodiments, dormant carbamate initiator systems may also be derived from such carbamates when at least a part of the protonated ammonium cations in these ammonium carbamate salts are replaced for quaternary ammonium cations, or other cationic species, or cationic polymers using synthetic approaches described above. For instance, piperazine is known to have a high capacity for carbon dioxide capture and shows a high heat of absorption as well. Piperazine forms various carbamates, e.g., protonated piperazine carbamate, piperazine carbamate and/or piperazine bicarbamate salts with mono or di protonated piperazine. The formation/decomposition equilibrium of carbamates is temperature dependent and varies depending on the amine employed as well as solvent/environment. In another embodiment, carbamates may be derived from pyrrolidine, 2-methylpyrrolidine, 3-methylpyrrolidine, piperidine, piperazine, methylethanolamine, diethanolamine, isopropanolamine, diisopropanolamine.

In yet another embodiment, carbamates may be derived from amines that have a pKa greater than 7, or carbamates derived from amines that have a pKa greater than 8, or carbamates derived from amines that have a pKa greater than 9, or carbamates that are derived from amines that have a pKa greater than 10.

### Formulation of Crosslinkable Composition

The crosslinkable composition useful as a coating can be formulated as a one component system, a two component system or a three component system. In an embodiment of a two component system, the chemical activator is added to a mixture of ingredients A and B just prior to use. In an alternative embodiment, ingredient A and the chemical activator are mixed, and ingredient B is added prior to use. In yet another embodiment, ingredient A is added to a mixture of ingredient B and the chemical activator prior to use. In certain embodiments, pot life, working time and gel time can be adjusted by selection of the carbamate structure, the amount used in the crosslinkable composition, presence of additional ammonium carbamate and, to a certain extent, the amount of solvent and/or water. A gel time of hours, and even days can be readily achieved, and gel times of weeks are possible. In certain embodiments, a one component system can be enhanced by means of using excess carbon dioxide gas over the crosslinkable composition to further improve pot life and gel time. For instance, a paint composition formulated according to the invention may have a protective atmosphere of carbon dioxide over the paint volume; and in yet another embodiment, a container containing the crosslinkable composition may even be pressurized with carbon dioxide. In yet another embodiment, additional ammonium carbamate may further enhance stability in such one component coating formulations.

In another embodiment, the present invention provides for the crosslinkable coating composition wherein ingredient A, ingredient B and the chemical activator are contained in a container having two or more chambers, which are separated from one another. In one such embodiment, ingredient A and ingredient B are contained in separate chambers to inhibit any reaction. In another such embodiment, the chemical activator is contained in the chamber having ingredient A, and optionally containing CO₂ and/or ammonium carbamate. In another such embodiment, the carbamate initiator is contained in the chamber having ingredient B, and optionally containing CO₂ and/or ammonium carbamate.

In another embodiment, the present invention provides for the crosslinkable coating composition such that ingredient A and ingredient B are contained in the same chamber and the carbamate initiator is contained in a separate chamber to inhibit any reaction and said separate chamber optionally containing CO₂ and/or ammonium carbamate.

In another embodiment, the present invention provides for the crosslinkable coating composition wherein ingredient A and ingredient B and chemical activator are contained in a container having a single chamber, wherein the container optionally contains CO₂ and/or ammonium carbamate.

Malonate esters are known to be susceptible to base hydrolysis, particularly when water is present. Water potentially can lead to undesirable destruction of initiator by means of formation of malonate salt and it can degrade malonate oligomers or polymers, which in turn can lead to altered coatings performance. Transesterification reactions also can occur with malonate esters and alcohol solvent. These reactions potentially can be limiting to the formulation of an acceptable working life, as a coating formulator seeks to increase pot life and gel time for a crosslinkable composition formulated either as a one or two component system. However, primary alcohols such as methanol and ethanol are much more active in transesterification reactions than secondary alcohols such as isopropanol, while tertiary alcohols are generally least active. Furthermore, additional resistance towards hydrolysis and transesterification can be obtained when malonate polyester resins are derived from malonic acid, or a dialkyl malonate such as diethyl malonate, and polyols bearing secondary alcohol groups; such as 2,3-butanediol, 2,4-pentanediol and 2,5-hexanediol and the like. The combination of such polyester resins and non-primary alcohol solvents, such as isopropanol or isobutanol, is particularly useful in achieving desirable resistance towards transesterification reactions. In a certain embodiment, resin ingredient A comprises malonate moieties that have been esterified with polyols bearing secondary alcohol groups and where secondary alcohol is present as solvent in the crosslinkable composition of this invention. In yet another embodiment, tertiary alcohols are used as solvent or solvents are used that do not participate in transesterification reactions. Other resins may also be formulated using such stabilizing approaches towards resin breakdown and such approaches are well known to one skilled in the art and need not be further described here.

In one embodiment, the crosslinkable composition of this invention comprising ingredients A, B and the chemical activator may optionally contain an additional ingredient C, which once activated, can react with the Michael acceptor. In one such embodiment, ingredient C has one or more reactive protons that are more reactive, i.e., more acidic than those of ingredient A (the pKa of ingredient C is lower than that of ingredient A), yet not as reactive as ammonium carbamate with respect the pKa. In another embodiment, ingredient C may be more acidic than ammonium carbamate with respect to pKa. In such embodiments, the reactive protons of ingredient C are present at a fraction based on the reactive protons of ingredient A where the fraction ranges from 0 to 0.5, or from 0 to 0.35, or between 0 and 0.15.

Examples of ingredient C include; succinimide, isatine, ethosuximide, phthalimide, 4-nitro-2-methylimidazole, 5,5-dimethylhydantoin, phenol, 1,2,4-triazole, ethylacetoacetate, 1,2,3-triazole, ethyl cyanoacetate, benzotriazole, acetylacetone, benzenesulfonamide, 1,3-cyclohexanedione, nitromethane, nitroethane, 2-nitropropane, diethyl malonate, 1,2,3-triazole-4,5-dicarboxylic acid ethyl ester, 1,2,4-triazole-3-carboxylic acid ethyl ester, 3-amino-1,2,4-triazole, 1H-1,2,3-triazole-5-carboxylic acid ethyl ester, 1H-[1,2,3]triazole-4-carbaldehyde, morpholine, purines such as purine, adenine, guanine, hypoxanthine, xanthine, theobromine, caffeine, uric acid and isoguanine; pyrimidines, such as thymine and cytosine; uracil, glycine, ethanimidamide, cysteamine, allantoin, N,N-dimethylglycine, allopurinol, N-methylpyrrolidine, benzeneboronic acid, salicylaldehyde, 3-hydroxybenzaldehyde, 1-naphthol, methylphenidate and Vitamin E.

In certain embodiments, ingredient C can significantly affect the initial cure speed and thus can generate longer open time.

In another embodiments, ingredient C may be incorporated into resin ingredient A. In such an embodiments, substituted succinimides, including hydroxyl group containing succinimide derivatives, 3-hydroxy-2,5-pyrrolidinedione and 3-(hydroxymethyl)-2,5-pyrrolidinedione, or carboxylic acid group containing succinimide derivative, 2,5-dioxo-3-pyrrolidinecarboxylic acid can undergo condensation reactions with either acid/ester groups or hydroxyl groups at the end of resin A polymer chain, where the succinimide moiety will be incorporated into the polymer backbone as end cap.

In yet another embodiment, maleimides can be copolymerized via radical process with acetoacetoxyethyl methacrylate (AAEM) to a copolymer that contains both acetoacetate group and succinimide groups.

In certain embodiments, the crosslinkable coating composition of this invention can comprise one or more pigments, dyes, effect pigments, phosphorescent pigments, flakes and fillers. Metal flake effect pigments may also be used in the crosslinkable coating composition of this invention.

In certain embodiments, the crosslinkable coating composition of this invention can comprise other Michael addition reactive and non-reactive resins or polymers, for instance to facilitate adhesion, and/or aid in coating removal. Such removal aids may be solvent-dissolvable compounds, resins, oligomers or polymers, which are dispersed in the polymerized structure and can be easily dissolved by a solvent to facilitate solvent absorption and migration during removal of the coating.

In certain other embodiments, the crosslinkable coating composition of this invention may optionally comprise resins, such as, but not limited to nitrocellulose, polyvinylbutyral tosylamide formaldehyde and/or tosylamide epoxy resins. Such resins may act as film formers, adhesion promoters, and aids to removal. These resins may also qualify as solvent-dissolvable resins. Nonreactive polymers may also be added to the formulation, and compounds such as 1,3-butanediol may optionally be added to alter properties such as gloss.

In some embodiments, the crosslinkable coating composition of this invention can comprise optional additives such as wetting agents, defoamers, rheological control agents, ultraviolet (UV) light stabilizers, dispersing agents, optical brighteners, gloss additives, radical inhibitors, radical initiators, adhesion promotors, plasticizers and combinations thereof.

The following examples further describe and demonstrate illustrative embodiments within the scope of the present invention. The examples are given solely for illustration and are not to be construed as limitations of this invention as many variations are possible without departing from the spirit and scope thereof.

### Example 1

### Malonate Donor Resin (I) Synthesis.

To a 0.5 liter, 4-neck glass reactor equipped with an overhead stirrer, a dean-stark trap, a condenser and thermocouple was charged 107.8 g of neopentyl glycol, 74.0 g of 1,2-cyclohexanedicarboxylic anhydride and 0.54 g of p-toluene sulfonic acid. The reaction mixture was slowly heated to 240° C. under nitrogen, and the reaction was continued to an acid value of 1.0 mg KOH/g. The mixture was cooled down to 130° C. and 110 g of diethyl malonate (DEM) was added. The reaction mixture was heated to 180° C. The reaction is continued until no significant amount of ethanol collected in one hour, then the reaction mixture was cooled down to 120° C. and diluted with 25.5 g of butyl acetate to a 90% solid. The final resin had number average molecular weight of 1400 Da and a weight average molecular weight of 3168 Da.

### Example 2

### Malonate Donor Resin (II) Synthesis.

To a 1 liter, 4-neck glass reactor equipped with an overhead stirrer, a dean-stark trap, a condenser and thermocouple was charged 250 g of diethyl malonate, 221.4 g of 1,6-hexanediol, 81.3 g of ethyl acetoacetate and 0.22 g of phosphoric acid. The reaction mixture was slowly heated to 180° C. under nitrogen, the reaction is continued until no significant amount of ethanol collected in one hour. Then the reaction mixture is cooled to 120° C. and vacuum is applied with ˜0.2 LPM N2 flow. In laboratory setup the 15-20 torr of vacuum is achieved using vacuum pump. The reaction is continued for four hours to drive the reaction to completeness.

### Example 3

### Synthesis of Acetoacetate Donor Resin (III).

A 500 mL reactor was charged with 45.8 g trimethylolpropane (0.3414 moles) and 150 g tert-butyl acetoacetate (0.9482 moles) to synthesize propane-1,1,1-triyltrimethyl tris(acetoacetate). The reactor was equipped with a Dean-Stark apparatus, overhead mechanical stirrer, nitrogen flow and heating equipment. The mixture was heated to about 120° C. with stirring under nitrogen and then 4 drops of titanium (IV) butoxide catalyst acid was added. Temperature of the reaction increased to 125° C. and tert-butanol start to distill at this temperature. Temperature was then stepwise increased to 180° C. and continued until tert-butanol distillation stopped. Tert-butanol generation was used as measure for reaction progress. Reaction temperature was the lowered to 120° C. and vacuum was applied for 1.5 hours. Acetoacetate methylene equivalent molecular weight of 132.5 g/mol.

### Example 4

### Synthesis of Carbamate Initiator.

A 500 mL jacketed reactor, equipped with overhead mechanical stirrer and re-circulator, was charged with 78 g of tert-butanol (1.05 moles), and purged with N2 for 10 min. 70 g of methyltrialkylammonium chloride (0.1617 moles) was added at 25° C. followed by 58.57 g of propylammonium propylcarbamate (PAPC) (0.1698 moles, conc. 2.90 meq./g, which was made by passing CO₂ through 40 wt. % solution of propylamine in tert-butanol). The reaction contents were mix for 20-30 min. Temperature of the reaction mixture was then raised to 28° C., 18.51 g potassium tert-butoxide (0.1650 moles) was added by splitting in 3 feeds, 45 min apart. Addition was followed by exotherm of 6-7° C., temperature of the reaction mixture was hence maintained at about 35° C. After the last addition of potassium tert-butoxide, it was stirred for an hour at 35° C. and then cooled to 25° C. It was treated with CO₂ (1 LPM) to convert the propylamine generated in the reaction to propylammonium propylcarbamate. Reaction mixture was filtered to remove precipitate generated in the reaction. Final product is colorless/light yellow in color.

### Example 5

### Synthesis of Carbonate Catalyst.

7.0 g (0.015 moles) of Tetrabutylammonium hydroxide (55 w % solution in water), 0.83 g (0.046 moles) of water and 4.85 g (0.0807 moles) of propanol were added to an appropriately sized container. The contents were mixed for 5 min to get a homogenous solution. Next, diethyl carbonate 2.936 g (0.25 moles) was slowly added to the above solution. It was then heated at 60° C. for 4 h to get the desired catalyst.

### Example 6

### Synthesis of Acrylate Based Surface Modifying Agent (I).

To a 0.5 liter, 4-neck glass reactor equipped with an overhead stirrer and a thermocouple was charged 390 mmol butyl acrylate, 29 mmol glycidyl methacrylate and 150.0 g of toluene. The mixture was heated to 80° C. under nitrogen, and 0.64 g of AIBN was added in two portions, one hour apart. The reaction was continued for 5 hours. Solvent removal in subsequent work up resulted in a polymeric liquid additive characterized by a molecular weight of 25,000.

### Example 7

Synthesis of Acrylate Based Surface Modifying Agent (II).

In a similar synthetic procedure as per example 6, a surface modifying agent was prepared using 2-ethylhexyl acrylate and butyl acrylate in a 2:15 molar ratio to obtain a polymer after work up with a molecular weight of about 4800.

### Example 8

### Synthesis of Acrylate Based Surface Modifying Agent (III).

In a similar synthetic procedure as per example 6, a surface modifying agent was prepared using butyl acrylate, 2-ethylhexyl acrylate and a fluorinated acrylate in a 5:30:1 molar ratio to obtain a polymer after work up with a molecular weight of about 8200.

### Additional Materials

Commercial acrylate resins: CN 9007 difunctional aliphatic urethane acrylate oligomer, CN 929 trifunctional aliphatic polyester urethane acrylate oligomer, SR 355 di(trimethylolpropane) tetraacrylate (DTMPTA) crosslinker and CN 9039 hexafunctional aliphatic urethane acrylate oligomer were all obtained from Sartomer/Arkema.

Ethyl acetoacetate (EAA), Diethylmalonate (DEM) and butyl acetate (BA) were obtained from laboratory supply vendors.

### Inventive Coating Example 1

In an appropriately sized container were mixed together either donor resin I or II with a stoichiometric amount of SR 355 (DTMPTA), which all together comprised 90 wt % of a base formulation. An additional 6.0 wt % butyl acetate and 4.0 wt % of carbamate initiator or carbonate catalyst of examples 4 or 5 were added to complete the base formulation. Various additional materials were optionally added on top of the aforementioned base formulation mixture as per table I below. The contents were mixed well and then films were drawn using a 6 mil Bird bar type film applicator, and time to cure tack free was recorded and film appearance with respect to wrinkling was observed after cure. Standard coating lab practices, equipment and safety procedures were used for all preparations and evaluations. Tack free time was evaluated by lightly pressing a gloved index finger periodically onto the coating. The time when visible marks in the film are no longer left by the pressed finger, is then recorded as the tack free time. Gloss was measured using a handheld Micro-Tri-Gloss meter from BYK Instruments. Wrinkling was easily observed visually but for those film that had high gloss, measurements were also taken at 60 degrees in three different locations on the film to confirm gloss level.

TABLE I

| | | | | Surface | | | | |
|---|---|---|---|---|---|---|---|---|
| | | Carbamate | Carbonate | Modifying | | | 6 mil film | |
| | Donor | initiator | catalyst | agent (I) | EAA | DEM | Tack time | |
| No. | Resin # | Wt % | Wt % | Wt % | Wt % | Wt % | [min] | Appearance |
| 1 | I | 4 | — | — | — | — | 20 | Microwrinkles |
| 2 | II | 4 | — | — | — | — | 30 | Microwrinkles |
| 3 | I | 4 | — | 0.10 | — | — | N/A | Severe wrinkling |
| 4 | I | 4 | — | — | 4 | — | 16 | Microwrinkles |
| 5 | I | 4 | — | — | — | 4 | 18 | Microwrinkles |
| 6 | I | 4 | — | 0.10 | — | 4 | N/A | Severe wrinkling |
| 7 | I | 4 | — | 0.10 | 4 | — | 35 | Clear High gloss |
| 8 | I | — | 4 | 0.10 | 4 | — | 18 | Clear High gloss |
| 9 | I | 4 | — | 0.10 | 2 | — | 20 | Clear High gloss |
| 10 | I | 4 | — | 0.05 | 4 | — | 30 | Clear High gloss |
| 11 | I | 4 | — | 0.05 | 2 | — | 28 | Clear High gloss |
| 12 | I | 4 | — | 0.10 | 2 | 2 | 16 | Clear High gloss |
| 13 | I | 4 | — | 0.10 | 4 | 4 | 30 | Clear High gloss |
| 14 | II | 4 | — | 0.10 | 4 | — | 32 | Clear High gloss |
| 15 | II | — | 4 | 0.10 | 4 | — | 12.5 | Clear High gloss |

### Inventive Coating Example 2

Acetoacetate based donor resin III was added to an appropriately sized container and mixed with either; CN 9007 difunctional aliphatic urethane acrylate oligomer, CN 929 trifunctional aliphatic polyester urethane acrylate oligomer, or CN 9039 hexafunctional aliphatic urethane acrylate resin. A stoichiometric ratio between donor and acceptor moieties was maintained. 5 wt % Carbamate initiator and a surface modifying agent was added as per table II to achieve an indicated solids level. Additional butylacetate solvent was used to complete the formulation. The contents were mixed well and then films were drawn using a 6 mil Bird bar type film applicator, and time to cure tack free was recorded and film appearance with respect to wrinkling was observed after cure.

TABLE II

| | | Surface | Surface | | 6 mil film | |
|---|---|---|---|---|---|---|
| | | Modifying | Modifying | | Tack | |
| | Acceptor | agent (II) | agent (III) | Solids | time | |
| No. | Resin | Wt % | Wt % | Wt % | [min] | Appearance |
| 20 | CN929 | — | — | 85 | 27 | Mild micro- |
| | | | | | | wrinkled |
| 21 | CN9007 | — | — | 85 | >72 | Mild micro- |
| | | | | | | wrinkled |
| 22 | CN9039 | — | — | 85 | 8 | Micro- |
| | | | | | | wrinkled |
| 23 | CN929 | — | 0.10 | 85 | 27 | Clear Glossy |
| 24 | CN9007 | — | 0.10 | 85 | >60 | Clear |
| 25 | CN9039 | — | 0.10 | 85 | 17 | Clear Glossy |
| 26 | CN9039 | — | 0.05 | 85 | 17 | Clear, much |
| | | | | | | glossier |
| 27 | CN9007 | 0.10 | — | 85 | 75 | Clear Glossy |
| 28 | CN9039 | 0.10 | — | 90 | 23 | Clear Glossy |
| 28 | CN9039 | 0.05 | — | 90 | 18 | Clear Glossy |

### Inventive Coating Example 3

In an appropriately sized container were mixed either donor resin I or II with a 10000 or 120 mol 00 stoichiometric amount of acceptor resin SR 355 (DTMPTA), which all together comprised 90 wt % of the base formulation. An additional 6.0 wt % butyl acetate and 4.0 wt % of carbamate initiator examples 4 or 5 were added to complete the base. Various additional materials were optionally added on top of the aforementioned base formulation mixture as per table III below. The contents were mixed well and then films were drawn using a 6 mil Bird bar type film applicator, and time to cure tack free was recorded and film appearance with respect to wrinkling was observed after cure.

TABLE III

| | | | | Surface | 6 mil film | |
|---|---|---|---|---|---|---|
| | | | Donor | Modifying | Tack | |
| | Donor | | resin III | agent (III) | time | |
| No. | resin # | DTMPTA | Wt % | Wt % | [min] | Appearance |
| 1 | I | 100% | — | — | 20 | Micro-wrinkled |
| 2 | II | 100% | — | — | 30 | Micro-winkled |
| 16 | I | 100% | 4 | 0.01 | 28 | High gloss, |
| | | | | | | clear |
| 17 | II | 100% | 4 | 0.01 | 27 | High gloss, |
| | | | | | | clear |
| 18 | I | 120% | 4 | 0.01 | 29 | High gloss, |
| | | | | | | very clear |
| 19 | II | 120% | 4 | 0.01 | 23 | High gloss, |
| | | | | | | very clear |

The present disclosure may be embodied in other specific forms without departing from the spirit or essential attributes of the invention. Accordingly, reference should be made to the appended claims, rather than the foregoing specification, as indicating the scope of the disclosure. Although the foregoing description is directed to the preferred embodiments of the disclosure, it is noted that other variations and modification will be apparent to those skilled in the art and may be made without departing from the spirit or scope of the disclosure.

All publications, patents and patent applications referred to herein are incorporated by reference in their entirety to the same extent as if each individual publication, patent or patent application was specifically and individually indicated to be incorporated by reference in its entirety.

1. A crosslinkable coating composition comprising:
ingredient A that has at least two protons that can be activated to form a Michael carbanion donor, wherein ingredient A is selected from the group consisting of an acetoacetate group containing compound, an acetoacetate group containing oligomer, an acetoacetate group containing polymer and combinations thereof;
ingredient B that functions as a Michael acceptor having at least two ethylenically unsaturated functionalities each activated by an electron-withdrawing group;
a surface modifying agent selected from the group consisting of perfluorosurfactants, polyacrylates, polyacrylate copolymers, fluorocarbon polyacrylates, fluorocarbon polyacrylate copolymers, polysiloxane and copolymers thereof and combinations thereof,
a chemical activator selected from the group consisting of: (i) a dormant carbamate initiator of Formula (1) 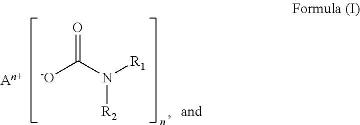
wherein R₁ and R₂ can be independently selected from hydrogen, a linear or branched substituted or unsubstituted alkyl group having 1 to 22 carbon atoms; 1 to 8 carbon atoms; or 1 to 4 carbon atoms;
(ii) a dormant carbonate initiator of Formula (2)

| | |
|---|---|
| 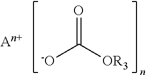 | Formula (2) |

wherein R₃ is H, or an alkyl group with 1 to 22, 1 to 8 or 1 to 4 carbon atoms; and (iii) combinations thereof;
wherein Aⁿ⁺ is a cationic species or polymer and n is an integer equal or greater than 1 with the proviso that Aⁿ⁺ is not an acidic hydrogen.

2. The crosslinkable coating composition according to claim 1, wherein the acetoacetate group containing compound, oligomer, or acetoacetate group containing polymer are each selected from the group consisting of: polyurethanes, polyesters, polyacrylates, epoxy polymers, polyamides, polyesteramides and polyvinyl polymers

3. The crosslinkable coating composition according to claim 1, wherein ingredient B is selected from the group consisting of acrylates, fumarates, maleates and combinations thereof.

4. The crosslinkable coating composition according to claim 3, wherein the acrylate is independently selected from the group consisting of hexanediol diacrylate, trimethylolpropane triacrylate, pentaerythritol triacrylate, di-trimethylolpropane tetraacrylate, bis(2-hydroxyethyl acrylate) trimethylhexyl dicarbamate, bis(2-hydroxyethyl acrylate), 1,3,3-trimethylcyclohexyl dicarbamate, bis(2-hydroxyethyl acrylate) methylene dicyclohexyl dicarbamate and combinations thereof.

5. The crosslinkable coating composition according to claim 1, wherein ingredient B is independently selected from the group consisting of polyesters, polyesterurethanes, polyurethanes, polyethers and/or alkyd resins each containing at least two pendant ethylenically unsaturated groups each activated by an electron-withdrawing group.

6. The crosslinkable coating composition according to claim 1, wherein ingredient B is independently selected from the group consisting of polyesters, polyester urethanes, polyurethanes, polyethers, alkyd resins each containing at least one pendant acryloyl functional group, and combinations thereof.

7. The crosslinkable coating composition according to claim 1, further comprising an ingredient C having one or more reactive protons that are more acidic than the protons of ingredient A, with respect to pKa.

8. The crosslinkable coating composition according to claim 1, further comprising less than 10 wt. %; 5 wt. %; 1 wt. %; 0.1 wt. %; 0.01 wt. % water.

9. The crosslinkable coating composition according to claim 1, being substantially free of water.

10. The crosslinkable coating composition according to claim 1, further comprising an organic solvent.

11. The crosslinkable coating composition according to claim 10, wherein the organic solvent is independently selected from the group consisting of an alcohol, ester, ether, glycol ether, ketone, aromatic and combinations thereof.

12. The crosslinkable coating composition according to claim 11, wherein the alcohol is independently selected from the group consisting of ethanol, iso-propanol, butanol, iso-butanol, t-butanol, ethyl acetate, butyl acetate, methyl ethyl ketone and combinations thereof.

13. The crosslinkable coating composition according to claim 1, further comprising ammonium carbamate (H₂NR₁R₂⁺⁻OC═ONR₁R₂).

14. The crosslinkable coating composition according to claim 1, wherein the dormant carbamate initiator initiates Michael Addition to achieve cross linking when the crosslinkable coating composition is applied to a surface.

15. A coating composition comprising the crosslinkable coating composition according to claim 1.
